(19) United States
(12) Patent Application Publication
(10) Pub. No.: US 2026/0250510 A1
(43) Pub. Date: Aug. 27, 2026

(54) RECYCLEABLE BIOPLASTIC COMPOSITES, METHODS OF MANUFACTURE THEREOF AND ARTICLES COMPRISING THE SAME

(71) Applicant: UNIVERSITY OF CONNECTICUT, Farmington, CT (US)

(72) Inventors: Challa Vijaya KUMAR, Ashford, CT (US); Adekeye Damilola KAYODE, Irvington, NJ (US); Ankarao KALLURI, South Plainfield, NJ (US)

(21) Appl. No.: 19/472,946

(22) PCT Filed: Apr. 10, 2024
(86) PCT No.: PCT/US2024/023901

§ 371 Date: Oct. 6, 2025

Related U.S. Application Data
(60) Provisional application No. 63/458,280, filed on Apr. 10, 2023.

(51) Int. Cl. C08L 89/00; C08J 5/24; C08K 3/04

(52) U.S. Cl. CPC C08L 89/00; C08J 5/247; C08J 5/249; C08K 3/042; C08J 2389/00; C08K 2201/001; C08K 2201/011; C08L 2205/08; C08L 2205/16

(57) ABSTRACT

A recyclable composition includes a proteinaceous biopolymer. The proteinaceous biopolymer forms a matrix of the recyclable composition and encapsulates a recyclable polymer. The recyclable polymer is dispersed in the proteinaceous biopolymer. A method of manufacturing a recyclable composition includes blending a proteinaceous biopolymer with a recyclable polymer to form the recyclable composition. The proteinaceous biopolymer forms a matrix of the recyclable composition and the recyclable polymer is dispersed in the proteinaceous biopolymer.

### CROSS-REFERENCE TO RELATED APPLICATIONS

This application claims priority to U.S. Provisional Application No. 63/458,280 filed on Apr. 10, 2024, the contents of which are hereby incorporated by reference in their entirety.

### BACKGROUND OF THE INVENTION

### Field of the Invention

This disclosure relates to bioplastic composites, methods of manufacture thereof and articles comprising the same. More specifically, this disclosure relates to recyclable bioplastics that include recycled textiles and plastic products.

### Description of Related Art

Over 90% of naturally-occurring and synthetic organic polymers often end up as waste (hereinafter “plastic waste”) in landfills after being used for their original intended purpose. Examples of such plastic waste include food packaging, computers, plastic furniture, textiles, trash bags, and the like. Plastic waste, once thrown away usually ends up buried deep in landfills where it can take over 500 years to decompose. This waste can sometimes leach harmful chemicals into the environment that can contaminate groundwater and soil.

Plastic waste that is not recycled often gets washed into streams, rivers, lakes and the sea, where it generates microplastic and nanoplastic particles that are harmful to flora and fauna as well as humans. In order to minimize the amount of plastic waste that is deposited in landfills, it is desirable to find new methods of recycling plastics and textiles in general and in particular plastic waste.

### SUMMARY OF THE INVENTION

A recyclable composition includes a proteinaceous biopolymer. The proteinaceous biopolymer forms a matrix of the recyclable composition and encapsulates a recyclable material. The recyclable polymer is dispersed in the proteinaceous biopolymer.

A method of manufacturing a recyclable composition includes blending a proteinaceous biopolymer with a recyclable material to form the recyclable composition. The proteinaceous biopolymer forms a matrix of the recyclable composition and the recyclable material is dispersed in the proteinaceous biopolymer.

### DETAILED DESCRIPTION OF THE INVENTION

Disclosed herein is a recyclable composition (hereinafter “composition”) that includes a proteinaceous biopolymer and a material that is typically recycled (hereinafter “recycled material”). The recycled material may be a textile, paper, a polymeric component derived from waste resins, or a combination thereof. The recycled material includes any waste fibers, sheets, shavings, and the like, that would normally be discarded to a landfill, but could be recycled if desired. The term “recyclable” refers to materials or products that can be processed or converted into new products through recycling processes. In other words, recyclable materials are those that can be collected, sorted, cleaned, and transformed into raw materials or new products that can be used again.

The proteinaceous biopolymer is completely biodegradable into nutrients for microbes but serves as a binder for the recycled polymer, which is dispersed through a volume of the proteinaceous biopolymer. In other words, the proteinaceous biopolymer forms a matrix that encapsulates the recycled polymer and stratifies the solid. In an embodiment, the recycled polymer is pulverized into a fibrous or particulate powder that is dispersed through the volume of the proteinaceous biopolymer. The composition may be treated with optional additives and fabricated into 1, 2 or 3-dimensional articles.

In an embodiment, the composition is recyclable. It is a thermoplastic and can repeatedly be subjecting to melting and reshaped. In another embodiment, the composition is completely soluble in at least one solvent. The composition can therefore be dissolved when desired and reshaped. In yet another embodiment, the composition comprises a lightly crosslinked proteinaceous biopolymer that can also be melted and reshaped.

Manufacturing the recyclable composition offers several advantages, both environmental and economic. It conserves natural resources. Recycling reduces the need for raw materials, such as timber, minerals, and petroleum, thereby conserving natural resources. For example, recycling paper reduces the number of trees cut down for paper production. It reduces energy consumption because recycling typically uses less energy than producing goods from raw materials. It reduces the amount of waste sent to landfills or incinerators, helping to minimize environmental pollution and the need for additional landfill space. It reduces pollution associated with extracting, processing, and manufacturing new materials. For example, recycling plastic reduces the amount of plastic waste that ends up in oceans and ecosystems. The encapsulation of recyclable materials by the proteinaceous biopolymer prevents the escaping of plasticizers, antioxidants, anti-ozonants, and other additives into aquifers and other drinking water systems. Recycling produces fewer greenhouse gas emissions compared to manufacturing products from raw materials. For example, recycling paper reduces carbon dioxide emissions compared to producing paper from virgin wood fibers.

The proteinaceous biopolymer comprises a synthetically created or naturally occurring biomolecule or macromolecule that comprises one or more long chains of amino acid residues. Proteins differ from one another primarily in their sequence of amino acids, which are dictated by the nucleotide sequence of their genes, and which usually results in protein folding into a specific 3D structure that determines its biological activity as well as its chemical nature. The proteinaceous biopolymer is biodegradable and can be completely recycled during its lifetime.

The proteinaceous biopolymer is preferably soluble in water or an alcohol. The proteinaceous biopolymer is one that can interact with the recycled polymer via van der Waals forces, or can form either a hydrogen bond, a covalent bond, hydrophobic binding, an ionic bond, or a combination thereof with the recycled polymer. The proteinaceous polymer and the recycled polymer may therefore exist in the form of a compatibilized blend, or alternatively, may react with one another (via a covalent bond or an ionic bond) to form a copolymer.

Examples of proteins are glycoproteins, structural proteins, fibrous proteins, enzymes, proteoglycans, peptides, natural polypeptides, synthetic polypeptides, spherical proteins, oligosaccharides, polysaccharides, collagen, gelatin, elastin, zein, wheat gluten, casein, whey, gellan gum, carrageenan, guar gum, psyllium seed gum, yam starch powder, alginate, seaweed flour, tragacanth gum, karaya gum, curdlan, soy alginic acid, carboxymethylcellulose, agar-agar, carrageenans, locust bean gum, gelatin, alginate, arabinoxylan, arrowroot, cassia gum, cellulose, gum Arabic, karaya gum, konjac, kuzu, maltodextrin, marshmallow root, pectin, sodium alginate, starch, xanthan gum, b-glucan, fibrinogen, fibrin, thrombin, collagen, elastin, egg albumin, keratin, laminine, papain, bovine serum albumin (BSA), avidin, streptavidin, soybean protein, and the like, or a combination thereof.

In an embodiment, the proteinaceous biopolymers may be treated with a crosslinking agent (also known as a functionalizing agent) prior to or during the encapsulation of the recycled polymer. The functionalizing agent preferably includes reactive groups. The reactive groups can facilitate free-radical polymerization when activated by electromagnetic radiation, heat transfer, or a combination of electromagnetic radiation and heat transfer. The functionalizing agent preferably includes an unsaturated carboxylic acid or a derivative of an unsaturated carboxylic acid. Examples of unsaturated carboxylic acids include maleic acid, fumaric acid, itaconic acid, acrylic acid, methacrylic acid, crotonic acid, malonic acid, succinic acid, glutaric acid, adipic acid, pimelic acid, suberic acid, azelaic acid, sebacic acids, citraconic acid, or the like, or combinations thereof. Examples of derivatives of unsaturated carboxylic acids are maleic anhydride, acrylic anhydride, methacrylic anhydride, citraconic anhydride, itaconic anhydride, malonic anhydride, succinic anhydride, glutaric anhydride, adipic anhydride, pimelic anhydride, suberic anhydride, azelaic anhydride, methyl acrylate, methyl methacrylate, ethyl acrylate, ethyl methacrylate, butyl acrylate, butyl methacrylate, glycidyl acrylate, glycidyl methacrylate, or the like, or a combination thereof. A preferred reactive group for functionalizing the proteinaceous biopolymer is a succinic anhydride, a methacrylic anhydride, or a combination thereof.

In an embodiment, the functionalizing agent may contain one or more substituents that can provide the proteinaceous biopolymer with various desirable properties. One desirable property is hydrophobicity. Suitable substituents includes one or more alkyl groups, oxygen, nitrogen, sulfur or phosphorus. In an embodiment, the substituent may include an alkyl having 4 to 20 carbon atoms, preferably 7 to 12 carbon atoms.

An exemplary functionalizing agent is an alkylsuccinic anhydride having 8 to 18 carbon atoms. The functionalizing agent may be added in an amount of 1 to 10 wt %, preferably 2 to 5 wt %, based on a total weight of the proteinaceous biopolymer.

Preferred proteinaceous biopolymers include bovine serum albumin (BSA), whey, papain, or a combination thereof. The proteinaceous biopolymers can be used in amounts of 5 to 90 wt %, preferably 10 to 50 wt %, and more preferably 15 to 45 wt %, based on a total weight of the composition.

The recycled material may include a polymer (prior to the process of forming the disclosed composition) that includes an organic polymer and may originally be in the form of a one, two or three dimensional article (e.g., a fiber, a wire, electrical insulation, crockery and cutlery, a board, a fabric, furniture, exterior body panels of automobiles, automobile bumpers, cookware, plastic wrap used in packaging, pallets, and the like). Preferred recycled polymers are in the form of fibers (prior to forming a textile) or in the form of a woven or non-woven textile.

In one embodiment, the woven or non-woven textile may comprise a naturally occurring fiber such as cotton, silk, jute, hemp, coir, bamboo, abaca, coir, lyocell, modal, sisal, and the like, or a combination thereof. In another embodiment, the woven or non-woven textile may comprise a synthetic organic polymer. Organic polymers that are present in one, two or three dimensional articles are listed below.

The polymer (that is used as the recycled polymer) may be a thermoplastic polymer, a blend of thermoplastic polymers, a thermosetting polymer, or a blend of a thermoplastic polymer with a thermosetting polymer. The organic polymer may also be a blend of polymers, copolymers, terpolymers, or a combination thereof. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination thereof.

Examples of thermoplastic polymers present in the recycled polymer includes polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Examples of polyelectrolytes present in the recycled polymer includes polystyrene sulfonic acid, polyacrylic acid, pectin, carrageenan, alginates, carboxymethylcellulose, polyvinylpyrrolidone, or the like, or a combination thereof.

Examples of thermosetting polymers present in the recycled polymer includes epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

The recycled material may also include paper and paper products. Papers include a material made from cellulose fibers derived from wood, rags, or other sources, wood pulp, cotton, jute, bagasse, bamboo, or the like. It is primarily used for writing, printing, drawing, and packaging.

The recycled material (e.g., the recycled polymer or paper) may be added to the composition in various geometrical forms and shapes. It can be added in the form of pulverized micro-particles or micro-fibers; strips, sheets, whiskers, coils, shavings, tubes of length and width greater than 5 millimeters; 3-dimensional shapes such as cubes, rectangular cuboids, spheres, pyramids, ellipsoids, and the like, or a combination thereof. In an embodiment, the strips, sheets, whiskers, coils and/or tubes have an aspect ratio greater than 2, preferably greater than 5 and more preferably greater than 10.

In an embodiment, the recycled material is pulverized prior to being blended with the proteinaceous biopolymer. The recycled material may be uniformly dispersed throughout the volume of the proteinaceous material. There may be a periodicity to the dispersed recycled material particles. The particle sizes of the dispersed recycled material are also uniform.

The pulverized recycled material may be in the form of particulates or fibers (micro-particles or micro-fibers) have an average particle size of 20 to 300 micrometers, preferably 25 to 250 micrometers and more preferably 50 to 200 micrometers.

In an embodiment, the particles or fibers of the recycled material after pulverization into particulates may optionally be subjected to a surface treatment to facilitate adhesion or bonding with the proteinaceous biopolymer. Silane or other coupling agents may be used to facilitate surface treatment of the recycled polymer. Examples of coupling agents are hexamethyldisilazane or trimethylchlorosilane. Epoxide or polyepoxide coupling agents may also be used to treat the surface of the recycled material.

In an embodiment, the recycled material is present in the composition in an amount of 10 to 95 wt %, preferably 15 to 85 wt % and more preferably 20 to 70 wt % of the composition.

In one embodiment, the recycled material (with or without pulverization) is blended with the proteinaceous biopolymer and subjecting to further processing. The blending can be dry blending, melt blending, solution blending, or a combination thereof.

Dry blending avoids the use of solvents, while wet blending includes the use of solvents that can partially or completely solvate one or both of the proteinaceous biopolymers and the recycled material. Melt blending includes melting at least one of the recycled material or the proteinaceous biopolymer during blending.

Solvents used for wet blending include water, alcohols, ketones, and the like. Alcohols include methanol, ethanol, butanol, propanol, or a combination thereof. Solvents that are not toxic to living beings are preferred. Water and ethanol are preferred solvents. Solvents may optionally be used to manufacture the composition. The composition may be present in the solvent in an amount of 10 to 80 wt %, preferably 25 to 60 wt %, based on a total weight of the composition and solvent.

Various additives may be added to the mixture of proteinaceous biopolymers and recycled polymer prior to blending. These additives include fillers such as, for example, natural and synthetic clays, reinforcing agents, dyes and colorants, glass beads, elastomers, impact modifiers, gelling agents, crushed tires, antioxidants, antiozonants, flame-retardants, thermal-stabilizers, mold release agents, and the like, or a combination thereof.

In an embodiment, the composition may be rendered electrically conducting by adding electrically conducting fillers such as metal particles, carbonaceous particles, electrically conducting ceramic particles, intrinsically conducting fillers, or a combination thereof to the composition. Metal particles include particulate or fibrous particles of copper, aluminum, steel, or a combination thereof. Carbonaceous particles include carbon black, Keltjen black, carbon nanotubes (single wall, double wall, multiwall carbon nanotubes, or a combination thereof), graphite particles and/or platelets, graphite oxide particles, graphene sheets, carbon fibers derived from pitch or polyacrylonitrile, or a combination thereof. Electrically conducting ceramic particles include indium tin oxide, antimony tin oxide, lanthanum-doped strontium titanate (SLT), yttrium-doped strontium titanate (SYT), or a combination thereof. Intrinsically electrically conducting polymer fillers include polyaniline, polythiophene, polyacetylene, polypyrrole, or a combination thereof. In an embodiment, the intrinsically conducting polymers may be used neutralized with an acid (e.g., dodecylbenzene sulfonic acid). Details of some of these electrically conductive fillers are provided below.

SWNTs used in the composition may be produced by laser-evaporation of graphite, carbon arc synthesis or the high-pressure carbon monoxide conversion process (HIPCO) process. These SWNTs generally have a single wall comprising a graphene sheet with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the composition. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general, the manner in which the graphene sheet is rolled up produces nanotubes of various helical structures. Zigzag and armchair nanotubes constitute two possible confirmations. In order to minimize the quantity of SWNTs utilized in the composition, it is generally desirable to have the composition comprise as large a fraction of metallic SWNTs.

MWNTs derived from processes such as laser ablation and carbon arc synthesis that are not directed at the production of SWNTs, may also be used in the compositions. MWNTs have at least two graphene layers bound around an inner hollow core. Hemispherical caps generally close both ends of the MWNTs, but it may be desirable to use MWNTs having only one hemispherical cap or MWNTs, which are devoid of both caps. MWNTs generally have diameters of about 2 to about 50 nm.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used the composition.

Activated carbon also called activated charcoal, is a form of carbon that has a surface area in excess of 3,000 m²/gm as determined by gas adsorption. It can be used in conjunction with other electrically conducting carbonaceous elements listed herewith.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalised π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semi-metal with unusual electronic properties that are best described by theories for massless relativistic particles.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the composition.

The electrically conducting fillers are added in amounts of 1 to 20 wt %, preferably 2 to 15 wt %, based on a total weight of the composition. It is desirable for the electrically conducting fillers to form a percolating network through the volume of the proteinaceous biopolymers. Combinations of the foregoing electrically conductive materials may be used in the composition. Compositions containing electrically conducting fillers may be electrically conducting. The compositions that contain electrically conducting fillers may be used in electrostatic discharge applications, electromagnetic dissipation applications and electrically conductive applications.

Plasticizers may also be added to the composition. Plasticizers may form hydrogen or electrostatic bonds with the proteinaceous biopolymer that increases the amount of free and freezing bond water retained in the biopolymer. Examples of plasticizers include glycerol, glycerin, glyceryl oleate, oleyl alcohol, polyethylene glycol (e.g., PEG-4, PEG-6, PEG-8, PEG- 12, PEG-16, PEG-20, PEG-32, PEG-75), stearic acid, oleic acid, sodium lactate, and the like, or a combination thereof.

In some embodiments, the composition may further comprise one or more humectants. Generally, a humectant is a water soluble solvent and any one of a group of hygroscopic substances with hydrating properties, i.e., used to keep things moist. They often are a molecule with several hydrophilic groups, most often hydroxyl groups; however, amines and carboxyl groups, sometimes esterified, can be used as well.

Non-limiting examples of some humectants include propylene glycol (E1520), hexylene glycol, and butylene glycol; glyceryl triacetate (E1518); vinyl alcohol; neoagarobiose; glycerol/glycerin, sorbitol (E420), xylitol, maltitol (E965), polymeric polyols (e.g., polydextrose (E1200)), quillaia (E999), urea, aloe vera gel, MP diol, alpha hydroxy acids (e.g., lactic acid), and the like, or a combination thereof.

Surfactants may also be added to the composition. Surfactants may be amphoteric surfactants, anionic surfactants, cationic surfactants, zwitterionic surfactants, or a combination thereof. An example of a surfactant is sodium dodecyl sulfate.

The proteinaceous biopolymer, the recycled material (in pulverized or in an unpulverized form) along with the additives may then be blended and molded to form an article. The blending of the proteinaceous biopolymer and recycled polymer can be conducted in a blender such as for example, single or multiple screw extruders, a Buss kneader, a Henschel, helicones, a Ross mixer, a Banbury, roll mills, molding machines such as injection molding machines, vacuum forming machines, blow molding machine, and then like, or a combination thereof.

The composition after blending may be molded into a desired shape. If a solvent is used to facilitate blending, then the composition is subjected to drying prior to being molded. Molding may include compression molding, injection molding, blow molding, vacuum forming, and the like. Articles manufactured from the composition include components for automobiles and aircraft, furniture, household objects such as brushes, combs, footwear, fabrics, plates, forks and spoons, housing for electronics, and the like.

The composition can be used to recycle polymeric products (especially textiles) and prevent the proliferation of plastic waste at landfills with the consequent pollution of underground water streams.

The composition and a method of manufacturing the composition is exemplified by the following non-limiting example.

### EXAMPLE

### Example 1

This example was conducted to demonstrate several compositions that contain the proteinaceous biopolymer and recycled polymers. The proteinaceous biopolymer is one of bovine serum albumin, hemp protein or papain protein.

The composition was manufactured by two different methods. In the first method, the recycled polymer was pulverized and mixed with the proteinaceous biopolymer prior to being subjected to molding. In the second method, the recycled polymer was not subjected to pulverization and was directly immersed in the proteinaceous biopolymer before being molded.

### First Method

The recycled polymer was waste clothing that contained cotton and wool. It was washed, dried, chopped into pieces and pulverized to get fibrous powder of particle sizes of 75 to 200 micrometers. The powdered fibrous powder were mixed with a solution of the proteinaceous biopolymers (BSA, papain, hemp) (200 to 600 mg/mL of the proteinaceous solution of pH 8-9). Water is used as a solvent to solubilize the BSA. When zein is used as the proteinaceous bioplastic, an ethanol-water or methanol-water combination containing 80 wt % of the alcohol is used to solubilize the zein. The proteinaceous biopolymers were present in the composition in an amount of 20 to 60 weight percent (wt %) to produce a paste.

The paste was then poured into a mold and subjected to drying at room temperature or at a temperature of 65° C. The dried samples were then examined to for their properties.

### Second Method

The raw waste clothing (the recycled polymer) was saturated with the BSA solution (200 to 600 mg/mL of the proteinaceous solution of pH 8-9) and allowed to dry at room temperature or at a temperature of 65° C. for 1 hour.

The composition and properties are shown in Table 1 below.

TABLE 1
Material composition and properties.

| | | | | Prospective/ | | |
|---|---|---|---|---|---|---|
| | | | Mass of | Potentially | | |
| | % | Volume | cotton/waste | developed | | Decomposition |
| Protein | solution | (mL) | clothing (g) | material | Rigidity/flexibility | by water |
| Bovine Serum Albumin | | | | | | |
| | 5 | 1.5 | 300 | No reaction | Very soft and flexible | ++ |
| | 10 | 1.5 | 300 | Mashed-Paper | Soft and flexible | ++ |
| | 15 | 1.5 | 300 | plastic | Rigid but flexible | ++ |
| | 20 | 1.5 | 300 | Soft wood | Rigid, hard and flexible | −− |
| | 25 | 1.5 | 300 | Soft wood | Rigid, hard, and Non-flexible | −− |
| | 30 | 1.5 | 300 | hard wood | Rigid, hard, and Non-flexible | −− |
| | 35 | 1.5 | 300 | Hard wood | Rigid, hard, and Non-flexible | −− |
| | 40 | 1.5 | 300 | Very hard | Rigid, hard, and Non-flexible | −− |
| | 50 | 1.5 | 300 | ceramic | Rigid, hard, and Non-flexible | −− |
| | 60 | 1.5 | 300 | Glass | Rigid, very hard, and Non-flexible | −− |
| Hemp protein | 5-60 | 1.5 | 300 | No reaction | No reaction | |
| Papain protein/enzyme | 5-30 | 1.5 | 300 | No reaction | No reaction | |
| | 40-60 | | | paper | Very soft and flexible | ++++ |

Note:
++ Decomposable;
−− non−decomposable;
++++: Decompose very easily

### Example 2

This example was conducted to demonstrate the encapsulation and recycling of paper by a proteinaceous biopolymer. The proteinaceous biopolymer is bovine serum albumin (BSA) modified with a hydrophobic anhydride (e.g., an alkylsuccinic anhydride; where the alkyl group has 18 carbon atoms) to make the composition more water resistant (except for the control sample, which did not contain the alkylsuccinic anhydride). The recycled material comprises paper that contains cellulose fibers. Additives were added to the composition. These include glucose oxidase enzyme, which was co-embedded in the composition.

Other additives include graphene (2.5% w/w in BSA solution). The graphene (that comprised a few layers of graphene in each particle) was co-embedded to improve the stiffness of the paper. Another additive that was used was carbon nanotubes. Multiwalled carbon nanotubes (1% w/w in BSA solution) enhanced the stiffness of the paper even more than graphene.

The respective concentrations and masses are listed in Table 2. These show that the compositions can be used in biocatalysis applications or for improved stiffness of the materials.

TABLE 2

| | | C18 Succinic | Glucose | | | |
|---|---|---|---|---|---|---|
| | | Anhydride | oxidase | | | |
| | Protein | (50 mg/mL) | (10 mg/mL) | Graphene | CNT | comments |
| 3 | 0.5 mL of BSA (250 | No | NA | NA | NA | Brittle films, not flexible, |
| | mg/mL) water, pH 9 | | | | | Control experiment |
| 4 | 0.5 mL of BSA (250 | 8% w/w of C18 | NA | NA | NA | Good films, flexible |
| | mg/mL) water, pH 9 | anhydride | | | | |
| 7 | 0.5 mL of BSA (250 | (200 μL, 10 mg) | 1 mg/mL | NA | NA | Good films, flexible |
| | mg/mL) water, pH 9 | | | | | |
| 11 | 0.5 mL of BSA (250 | | NA | 2.5% w/w | NA | Good films, flexible and |
| | mg/mL) water, pH 9 | | | | | stronger films due to |
| | | | | | | Graphene |
| 13 | 0.5 mL of BSA (250 | | NA | NA | 1.0% w/w | Good films, flexible and |
| | mg/mL) water, pH 9 | | | | | stronger films due to CNT |
| | | | | | | (Carbon nanotubes) |

From Table 2 it may be seen that the sample that did not contain the succinic anhydride, the glucose enzyme, the carbon nanotubes and the graphene was brittle. All of the other compositions provide strong films that are flexible and are monolithic.

The composition is advantageous in that it reduces problems pertaining to the environmental pollution by fabrics, paper or plastics. It resolves weight problems in automobiles, aircraft, furniture, electronics and buildings. It can be used as a replacement for wood, metals or non-degradable polymers. The manufacturing process for producing the composition is fast, green, sustainable, energy efficient and eco-friendly. It can be adhesively bonded (with glue) to wood, plastics, metals and ceramics. The resulting composition is completely recyclable.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A recyclable composition comprising:
a proteinaceous biopolymer; where the proteinaceous biopolymer forms a matrix of the recyclable composition; and
a recyclable material; where the recyclable material is dispersed in the proteinaceous biopolymer.

2. The recyclable composition of claim 1, where the proteinaceous biopolymer is recyclable.

3. The recyclable composition of claim 1, wherein the recyclable composition is soluble in a solvent.

4. The recyclable composition of claim 1, wherein the recyclable composition is a thermoplastic.

5. The recyclable composition of claim 1, where the proteinaceous biopolymer comprises glycoproteins, structural proteins, fibrous proteins, enzymes, proteoglycans, peptides, natural polypeptides, synthetic polypeptides, spherical proteins, oligosaccharides, polysaccharides, collagen, gelatin, elastin, zein, wheat gluten, casein, whey, gellan gum, carrageenan, guar gum, psyllium seed gum, yam starch powder, alginate, seaweed flour, tragacanth gum, karaya gum, curdlan, soy alginic acid, carboxymethylcellulose, agar-agar, carrageenans, locust bean gum, gelatin, alginate, arabinoxylan, arrowroot, cassia gum, cellulose, gum Arabic, karaya gum, konjac, kuzu, maltodextrin, marshmallow root, pectin, sodium alginate, starch, xanthan gum, b-glucan, fibrinogen, fibrin, thrombin, collagen, elastin, albumin, keratin, laminine, papain, bovine serum albumin, avidin, streptavidin, soybean protein, and the like, or a combination thereof.

6. The recyclable composition of claim 1, where the proteinaceous biopolymer is bovine serum albumin.

7. The recyclable composition of claim 1, where the proteinaceous biopolymer is present in an amount of 5 to 90 wt %, based on a total weight of the composition.

8. The recyclable composition of claim 1, where the recyclable material is in particulate or fibrous form having an average particle size of 20 to 300 micrometers prior to incorporation in the recyclable composition.

9. The recyclable composition of claim 1, where the recyclable material is in the form of a strip, a sheet, a whisker, a shaving, a coil and/or a tube that have an aspect ratio greater than 2.

10. The recyclable composition of claim 1, where the recyclable material comprises pulverized micro-particles or micro-fibers having an average particle size of 20 to 300 micrometers.

11. The recyclable composition of claim 1, where the recyclable material comprises strips, sheets, whiskers, coils, tubes of length and width greater than 5 millimeters.

12. The recyclable composition of claim 1, where the recyclable material comprises 3-dimensional shapes; where the three-dimensional shapes comprise cubes, rectangular cuboids, spheres, pyramids, ellipsoids, or a combination thereof.

13. The recyclable composition of claim 1, further comprising an electrically conducting filler.

14. The recyclable composition of claim 1, further comprising a plasticizer.

15. The recyclable composition of claim 1, wherein the recyclable composition is electrically conducting.

16. An article comprising the recyclable composition of claim 1.

17. A method of manufacturing a recyclable composition comprising:
blending a proteinaceous biopolymer with a recyclable material to form the recyclable composition; where the proteinaceous biopolymer forms a matrix of the recyclable composition; and dispersing the recyclable material in the proteinaceous biopolymer.

18. The method of claim 17, further comprising molding the recyclable composition.

19. The method of claim 17, further comprising dispersing an electrically conducting filler in the recyclable composition.

20. The method of claim 17, further comprising pulverizing the recyclable material prior to the blending.
